(19) United States
(12) Patent Application Publication
(10) Pub. No.: US 2017/0346924 A1
(43) Pub. Date: Nov. 30, 2017

(54) SYSTEM AND METHOD FOR PROVIDING RELIABLE AND EFFICIENT DATA TRANSFER

(71) Applicant: ACTIONTEC ELECTRONICS, INC., Sunnyvale, CA (US)

(72) Inventors: Bo XIONG, San Ramon, CA (US); Dean CHANG, Sunnyvale, CA (US); Chuang LI, Saratoga, CA (US)

(73) Assignee: ACTIONTEC ELECTRONICS, INC., Sunnyvale, CA (US)

(21) Appl. No.: 15/608,941

(22) Filed: May 30, 2017

Related U.S. Application Data
(60) Provisional application No. 62/343,460, filed on May 31, 2016.
(60) Provisional application No. 62/344,358, filed on Jun. 1, 2016.

(51) Int. Cl. H04L 29/08; G06F 3/06; G06F 17/30; G06F 9/455

(52) U.S. Cl. CPC H04L 67/327; H04L 67/1023; G06F 17/30849; G06F 17/30203; G06F 3/0619; G06F 3/0689; G06F 3/0665; G06F 3/0643; G06F 9/45529

(57) ABSTRACT

Systems and methods for providing reliable and efficient data transfer involving a user browser configured to run JavaScript which permits a user browser to communicate with components of a media distribution system. The user browser may request specific media content on the company website which may inform components of the media distribution system of the request. To facilitate the downloading of the requested media content, components of the media distribution system may arrange for the generation of a torrent files, informing the user browser where the requested media content may be downloaded. A fake torrent file may be generated and distributed to the user browser to permit viewing of the media content before generation of a real torrent file is possible. Upon receiving the torrent files, a user may download and play the media content.

### CROSS-REFERENCE TO RELATED APPLICATIONS

This application claims priority to U.S. Provisional Application No. 62/343,460 filed on May 31, 2016 and U.S. Provisional Application No. 62/344,358 filed on Jun. 1, 2016, the contents of which are incorporated herein by reference.

### FIELD OF THE INVENTION

The present invention relates generally to the field of data transfer and more particularly to transferring media content on the Internet.

### BACKGROUND

To reduce bandwidth requirements and provide more reliable Internet connectivity, the concept of the content delivery network (CDN) was developed. CDNs are servers strategically deployed in multiple locations around the world designed to shorten the distance between the user's personal computer and a website's server. CDNs store cached content and serve merely to deliver the content to the user's computer faster than the website's server.

Before the CDN was developed, to get content from an origin server to a requesting user computer, content typically had to travel through backbone servers and public network cables. Each stop meant more time to render the data and increased risk of Internet instability. CDNs streamlined the process by shortening the distance content must travel to arrive at the requesting computer. As CDNs exist all over the world, a client computer will often select the closest CDN, thereby eliminating or reducing the number of handoffs.

Recently, the CDN concept has been improved by HolaCDN, as described in U.S. Pat. No. 8,560,604, and continuation U.S. patent application No. 2014/0019514, which involves downloading video segments from multiple CDNs. HolaCDN is an overlay that sits on top of the existing CDN network and may include additional HolaCDN servers or nodes. HolaCDN is centered around mid-streaming switching between CDNs. HolaCDN streams media from numerous CDNs chosen according their geographic location, cost, speed and capacity. To save money, the first few video segments are served by the fastest server, closest to the user. Subsequent video segments are then served by servers that are cheaper and likely located in other regions.

The torrent file was also created to reduce download time and improve reliability of data transfer. The torrent file concept involves parsing media content into smaller pieces and downloading the smaller pieces from multiple sources. A torrent file itself, also called a torrent, provides metadata about the media content to be distributed. Using a client application, a user may request a specific media content file from the application and may in return receive a torrent file having the requisite information for downloading each piece of the requested media content. Recently, the torrent concept was improved with the WebTorrent. The WebTorrent replaces the client application with the user browser but functions similarly to the traditional torrent system. In this manner, the WebTorrent connects users together to form a distributed, browser-to-browser network for file transfer.

While use of CDNs and torrent files have improved media distribution and specifically video streaming, media distribution from CDNs remains costly and requires complicated infrastructure. Further, current torrent distribution schemes fail to provide robust and efficient data distribution typical of modern CDN distribution.

### SUMMARY OF THE INVENTION

The present invention is directed to systems and methods for downloading and streaming media content over the Internet. The systems and methods disclosed herein involve a user device which runs a user browser. The user browser may contact a company website which may contact a server portal from which the user browser may download and run RAIDCDN JavaScript to permit the user browser to send information to and receive information from components of the RAID CDN system.

The user browser, running RAIDCDN JavaScript may request specific media content from the company website which may pass that request to the portal server. The portal server may then pass the request to other RAID CDN system components which may arrange for the requested media content to be downloaded from content sources which may include but are not limited to peer user devices, RAID CDN, original CDN and RAID box. Specifically, the RAID CDN system may arrange for torrent files to be generated and distributed to the user browser. When downloaded by the user browser, the torrent files inform the user browser of where to download the media content from. Where media content is not available on the RAID CDN system, user device may download media content through traditional CDNs.

To allow the user browser to view media content prior to the content being downloaded entirely, two different types of torrent files may be generated. First, fake torrent files may be generated by a RAID box. Fake torrent files may instruct the user devices where to download some of the desired media content from. After the download of the requested media content has been completed, a real torrent file may be generated and distributed by the mirrorbrain CDN. The real torrent file provides content sources for all of the media content pieces.

The user browser may download multiple media content pieces simultaneously in parallel. The torrent files may provide distribution information for more than one content source that has the desired media content. Out of the content sources identified as having the desired media content, the most reliable and cost efficient content sources may be identified and selected for download. The same media content may be downloaded in parallel from multiple content sources. As the most reliable and cost efficient content sources may change while streaming the media content, the user browser may be redirected, mid-download, by RAIDCDN JavaScript between different content sources.

### BRIEF DESCRIPTION OF THE DRAWINGS

FIG. 1 is a view of the components of the RAID CDN system of the present invention.

FIG. 2 is a functional diagram of an exemplary embodiment of a user device.

FIG. 3 is a functional diagram of the components of the RAID CDN architecture of the present invention.

FIG. 4 is a detailed functional diagram illustrating the communication flow within the RAID CDN system of the present invention.

FIG. 5 is a functional diagram of an exemplary embodiment of the RAID CDN system of the present invention having multiple RAID CDNs and peer devices.

FIG. 6 is a flow chart illustrating the process for accessing the RAID CDN system severs from user browser.

FIG. 7 is a flow chart illustrating an exemplary embodiment of the RAID CDN architecture of the present invention wherein the media content has not been requested before.

FIG. 8 is a flow chart illustrating an exemplary embodiment of the RAID CDN architecture of the present invention wherein the media content has been requested before.

### DETAILED DESCRIPTION

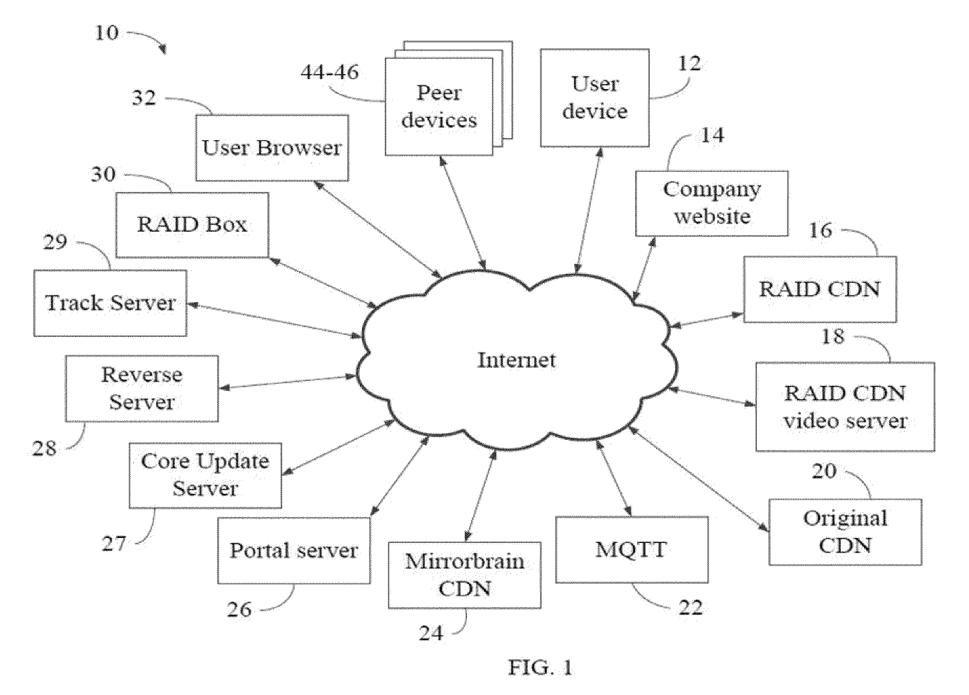

Referring to FIG. 1, a view of RAID CDN system 10 is shown. RAID CDN system 10 provides an efficient approach for transferring media content over the Internet to permit reliable media streaming on a user device. RAID CDN system 10 may be accessed using the Internet and may be a cloud based system. By generating torrent files, RAID CDN system 10 may provide user devices access to media content which may be downloaded in parallel from multiple content sources. RAID CDN system 10 may identify the fastest and most reliable content sources throughout the download and user devices may be redirected mid-download to faster and more reliable content sources. Content sources may consist of one or more of peer user devices, RAID CDN, RAID box, traditional or original CDNs or servers and devices within a traditional torrent network. Where content sources are peer devices, peer-to-peer data transfer may be achieved. RAID CDN system 10 also provides a better user experience by allowing users access to the media content before the torrent file is complete using a fake torrent technique. RAID box may be any computing device or computing system having processing capabilities sufficient to generate a fake torrent file and having the functionality described herein. Alternatively, or in addition to, RAID box may be other components of RAID CDN system 10 and may even be user or peer devices.

RAID CDN system 10 may include user device 12, one or more peer devices 44-46, RAID CDN 16, RAID CDN video server 18, original CDN 20, MQTT 22, mirrorbrain CDN 24 which may be a server or computing system having the functionality described herein, portal server 26, RAID box 30, user browser 32, core update server 27, reverse server 28 and track server 29. The components within RAID CDN system 10 may connect to one another over the Internet as shown in FIG. 1, or may connect to one another using a wired connection or a combination of wired connections and wireless connections. Several components within RAID CDN system 10 may be combined or reduced into a single component configured with functionality of numerous components described herein. Duplicate components may also be included in RAID CDN system 10. For example, several RAID CDNs 16 may be distributed globally. Further, RAID CDN system components may be dynamically virtualized to meet the user demand.

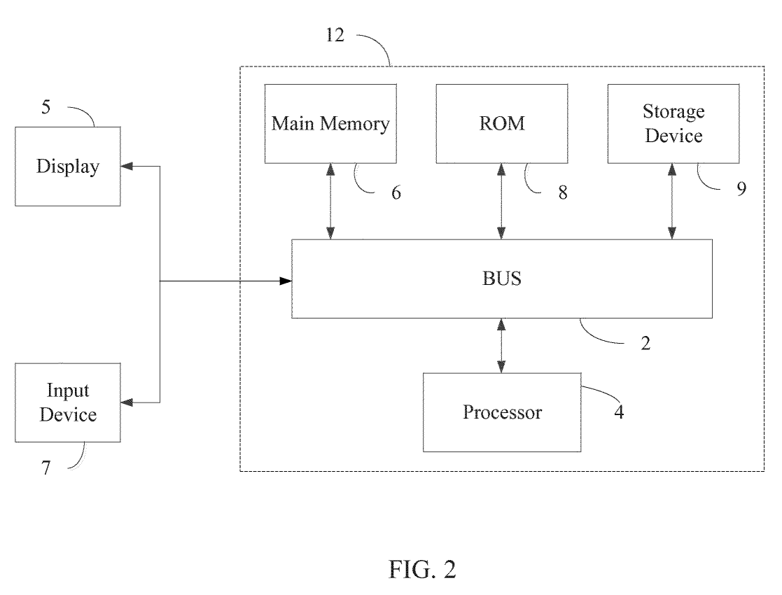

User device 12 may be any type of well-known computing device configured to connect to the Internet, including but not limited to a personal computer, laptop computer, tablet, smart phone, set-top box, embedded Internet-of-Things (IOT) device, steaming media player or a television equipped with the above mentioned devices. Peer user devices may similarly be any well-known computing devices configured to connect to the Internet. As disclosed in FIG. 2, user device 12 configured to run user browser 32 and RAIDCDN JavaScript may be a standard computing device including bus 2 or other communication component for communicating information and processor 4 or processing circuit coupled to bus 4 for processing information. User device 12 may include more than one processor and may also include main memory 6, such as random access memory (RAM) or other dynamic storage device coupled to bus 2 for storing information, and instructions to be executed by processor 4. User device 12 may further include read only memory (ROM) 8 or other static storage device coupled to bus 2. Storage device 9, such as a solid state device, magnetic disk or optical disk, is coupled to bus 2 for persistently storing information and instructions. User device 12 may be coupled via bus 2 to display 5. Additionally, input device 7, such as a keyboard, touchscreen, mouse, etc., may be coupled to bus 2 for communicating information and command selections to processor 4. User device 12 may download and store media content using one or more of main memory 6, ROM 8 and storage device 9.

Company website 14 may be any website configured to run RAIDCDN JavaScript. Company website 14 may provide a list of media content titles for download and may be in communication with servers having media content such as original CDN 20. Portal server 26 may be configured to provide a single point of access to the applications, services and information available in RAID CDN system 10 and may be configured to communicate with company website 14 and user browser 32.

RAID CDN video server 18 may be any computing server or computing system having the functionality described herein and may work in conjunction with MQTT 22, RAID CDN 16, RAID Box 30 and mirrorbrain CDN 24 to download requested media content. RAID CDN video server 18 may download the requested media content from content sources such as original CDN 20 and distribute the media content to RAID Box 30, mirrorbrain CDN 24 and RAID CDN 16. RAID box 30 may also download the requested media content from the same content sources. Original CDN 20 may be one or more original source of online content or a traditional content distribution network (CDN).

MQTT 22, short for Message Queue Telemetry Transport, is a messaging distribution server that may facilitate communication between user devices and various other components in the RAID CDN system such as mirrorbrain CDN 24 and RAID box 30. MQTT 22 may communicate a data link or may even communicate data and/or files to components in RAID CDN system 10. It is understood that MQTT 22 could be any messaging distribution protocol. Mirrorbrain CDN 24 may generate and store real torrent files as well as generate and store fake torrent files. RAID box 30 may generate and store fake torrent files. Additionally, any other component of RAID CDN system 10 could generate a fake torrent file including RAID CDN video server 18.

Core update server 27 is similar to the core update servers in traditional torrent networks and may periodically provide components of RAID CDN system 10 with software updates. Reverse server 28 is similar to the reverse servers in traditional torrent networks and may be a proxy server. Reverse server 28 may help debug RAID Box 30 and other components of the RAID CDN system when they fail to function normally. Track server 29 is similar to the track servers, also called tracker servers, in traditional torrent networks and may be used to keep track of peer devices 44-46 that have accessed torrent files as well as maintain various other statistics. In this way, track server 29 may help user devices find one another.

Portal server 26 may be accessible from user devices 12 over the Internet from all over the world. User devices running user browsers may contact company website 14 and be redirected to portal server 26. User browser 32 may be any type of well-known web browser. As described in more detail below, a user using user device 12 may contact company website 14 and through company website 14, user browser 32 may retrieve RAIDCDN JavaScript from portal server 26. Company website 14 may also run RAIDCDN JavaScript. User browser 32 may run the JavaScript to facilitate communication between user browser 32 and the other components in the RAID CDN system. Portal server 26 may similarly run JavaScript. Portal Server 26 may direct requests and commands received from user device 12 to other components of RAID CDN system 10.

RAID CDN system 10 may be a cloud based system. Cloudification may be achieved by moving RAID CDN system 10 components to the cloud. For example, the infrastructure of the cloud based system may include one or more of portal server 26, RAID CDN 16, RAID CDN video server 18, MQTT 22, RAID Box 30 and mirrorbrain CDN 24. The cloud infrastructure may also include one or more of track server 29, reverse server 28 and core update server 27 to help process data requests from user browser 32. The cloud infrastructure may manage and process the communication and data transfer between components of RAID CDN system 10.

The cloud infrastructure may simultaneously be accessed over the Internet by multiple user devices. As the use and demand for the components within the cloud infrastructure increases, the processing power and storage of the cloud infrastructure may increase proportionally. For example, duplicate components may be added or dynamically virtualized or hardware with increased functionality or better performance may be installed. In this way, the cloud infrastructure may be scalable depending on demand. Scalability is critical as use of the RAID CDN system 10 may fluctuate significantly over time and servers within the cloud infrastructure may become overloaded over time.

Multiple groups of cloud infrastructure may exist in either the same place or spread out geographically. The groups of cloud infrastructure may each include a portal server 26, RAID CDN 16, RAID CDN video server 18, MQTT 22, RAID Box 30 and mirrorbrain CDN 24 and additionally may include track server 29, reverse server 28 and core update server 27. Each group of cloud infrastructure may be in communication with each of the other groups either using a hard wired connection or through the Internet or some other well-known high-bandwidth communication technology. An example of a group is an edge cloud. Each group may consist of one or more of each component described as being included in the cloud infrastructure. For example, each group of cloud infrastructure may include several RAID CDN video servers. Alternatively, some groups may consist of fewer components. For example, multiple groups of cloud infrastructure may share the same RAID CDN video server 18 or portal server 26. It is also understood that the components of the cloud infrastructure may be located in close proximity but may be in communication via the Internet. For example, RAID CDN video server 18 may be located in a different building as RAID CDN 16.

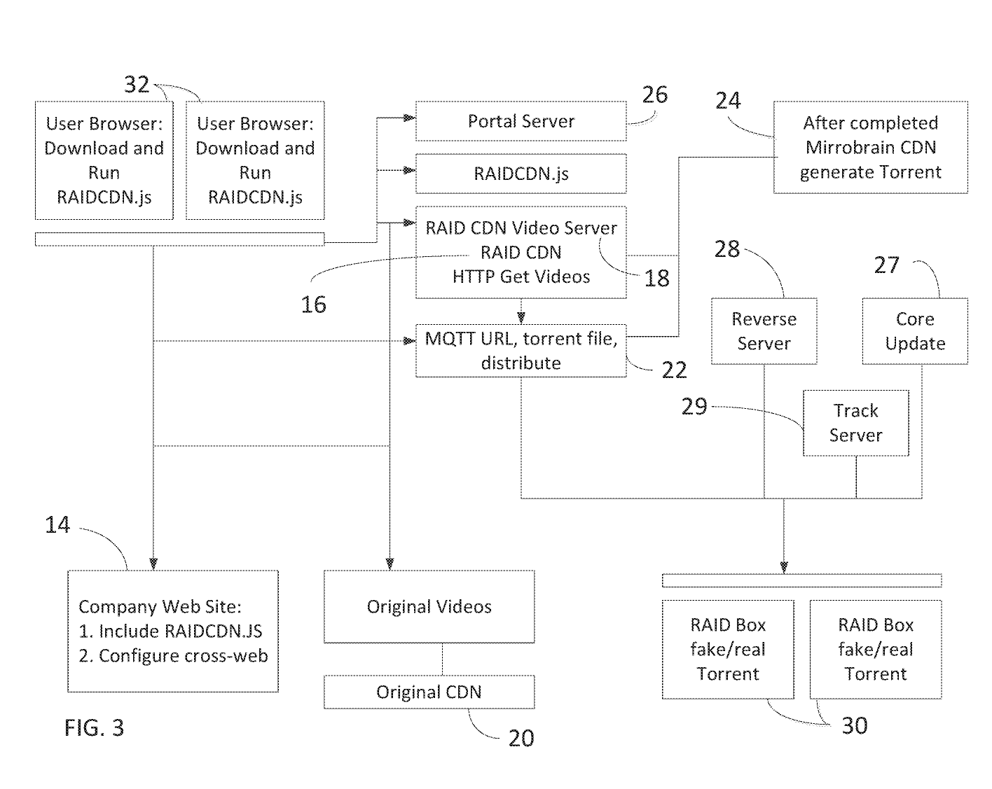

Referring now to FIG. 3, a functional diagram of RAID CDN system 10 is illustrated. The interconnectivity and communication flow between the components of RAID CDN system 10 permits user device 12 using user browser 32 to communicate information to other components of RAID CDN system 10 to ultimately arrange for user browser 32 to stream media content from various media content sources. Upon downloading media content, user device 12 may become a content source from which other peer devices may download media content.

To stream media content, user device 12 using user browser 32 may access company website 14. Company website 14 may then access portal server 26 by communicating over the Internet with portal server 26. Portal server 26 may be responsible for company website/client registration, payment and status checks among other responsibilities. Portal server may also be responsible for validating a client token received from company website 14. From portal server 26, user browser 32 may receive and run RAIDCDN JavaScript (RAIDCDN.js). RAIDCDN JavaScript may be stored on portal server 26 or alternatively may be stored on another server in the RAID CDN system to improve download time and reliability. Other peer devices may also access company website 14 and similarly receive RAIDCDN JavaScript from portal server 26. RAIDCDN JavaScript is comprised of executable instructions that when run on user browser 32 permits user browser 32 to, among other things, send information to portal server 26 and receive information through MQTT 22. Through MQTT 22, user browser 32 may receive information such as torrent files generated by mirrorbrain CDN 24 and RAID box 30. RAIDCDN JavaScript is the control module for all media content downloads including downloads from CDNs and peer devices. RAIDCDN JavaScript may include intelligence discussed in more detail below that permits user browser 32 to determine the most reliable and cost efficient content sources available and also may include logic that permits user browser 32 to track which content sources have specific media content. Additionally, as also discussed in more detail below, RAIDCDN JavaScript permits user devices to update torrent files such as fake torrent files.

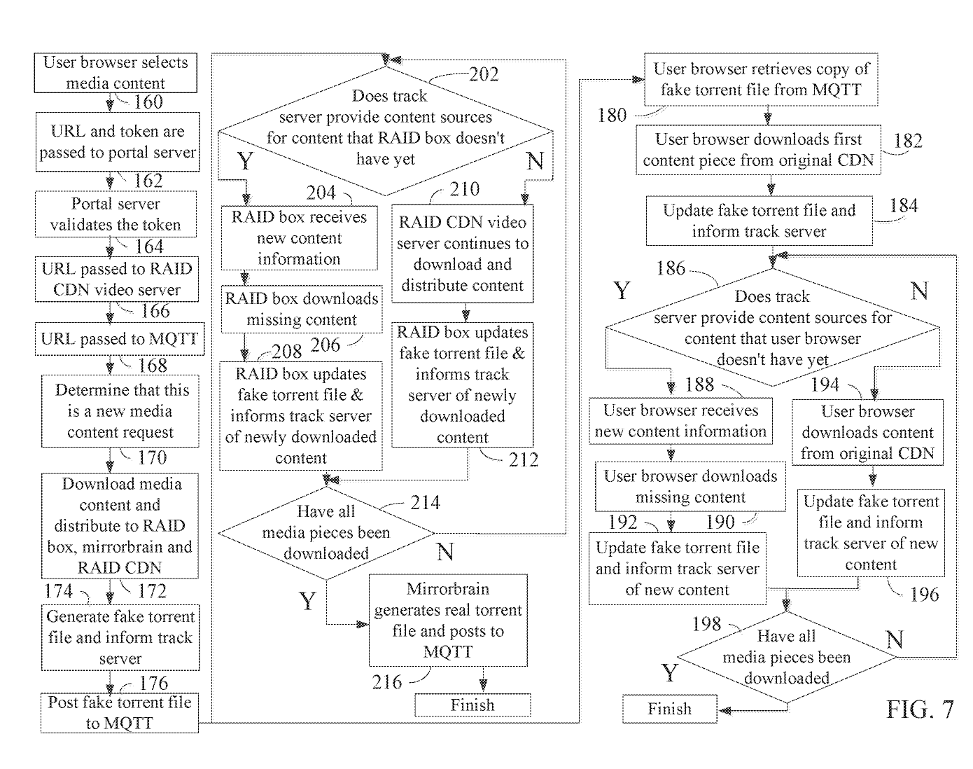

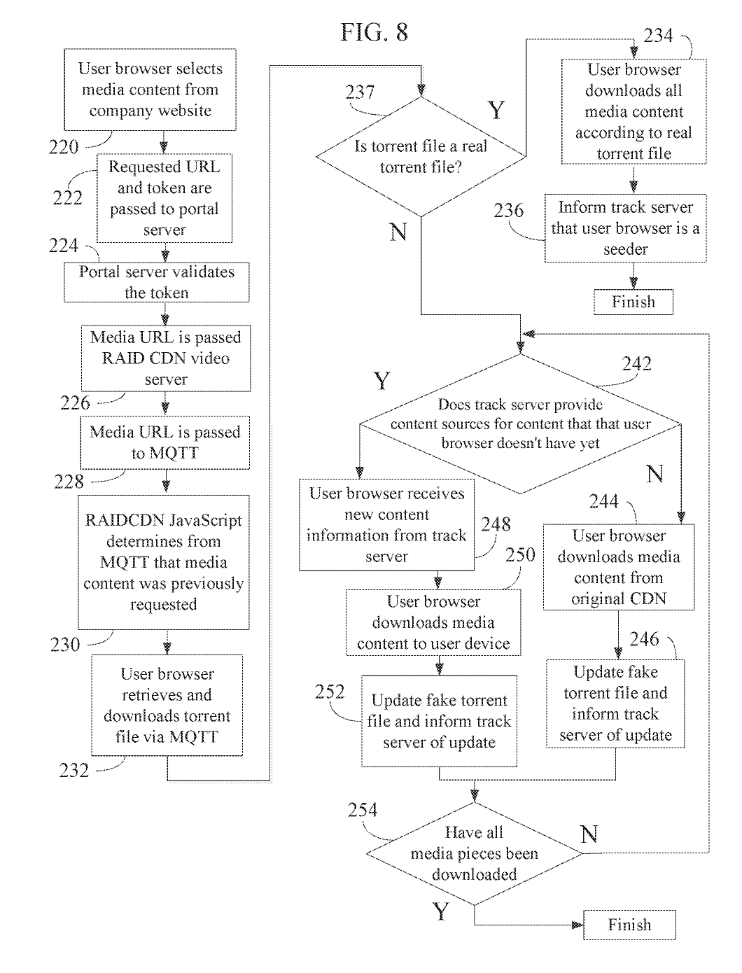

To obtain media content, user browser 32 may request specific media content from company website 14, at which point the requested media content will be communicated to portal server 26 by company website 14. For example, a user using user browser 32 may select a specific video title or album name from company website 14. That video title or album name may be communicated from company website 14 to portal server 26. Discussed in more detail in FIGS. 7 and 8, upon being informed of a request for specific media content, RAID CDN system 10 must determine if that media request has been made before and if it has not, RAID CDN system 10 may arrange for the media content identified in the request to be downloaded to servers in the RAID CDN system such as RAID CDN video server 18. A torrent file may be generated corresponding to the media content being downloaded.

The embedded RAIDCDN JavaScript may direct one or more components such as RAID CDN video server 18 to work in conjunction with one or more of RAID box 30 and mirrorbrain CDN 24 to arrange for torrent files to be generated in relation to the media content that is requested by user browser 32. Torrent files do not contain the media content requested but instead contain information about the content sources that have the desired media content as well as other information regarding distribution of the media content from the content sources. For example, a torrent file may provide the location of a peer device having the desired information. In this manner, torrent files may inform user browser 32 of where the desired media content may be downloaded from. The method of using a torrent file to download content pieces in the RAID CDN system 10 is similar to the method using a torrent file to download content pieces currently used by traditional torrent client applications.

To facilitate faster downloading time and reduce the work required of one content source, the media content may be broken up into pieces. To provide a user with the complete media content file, a torrent file may tell the user where to find each piece of the media content. The media content may be supplied from as many content sources as there are pieces. Alternatively, the torrent file may inform the user of multiple content sources from which each piece of media content may be retrieved, providing multiple options for downloading each piece of media content.

RAID CDN system 10 is configured to exchange two types of torrent files, fake torrent files and real torrent files. Real torrent files are similar to traditional torrent files and are generated only after the media content has been fully downloaded. Fake torrent files may be generated before or immediately after the media content begins downloading. Fake torrent files may be updated each time a piece of media content has finished downloading. As such, fake torrent files may be generated even though some or all of the requested pieces of media content have not yet downloaded or are still in the process of being downloaded. Unlike real torrent files, fake torrent files may provide information for one or more pieces of media content that have been downloaded and may provide placeholders or other information and/or fake data for the media content pieces not yet downloaded or finished being downloaded. Where no media content has been downloaded yet, fake torrent files may still be generated which may include information about associated track servers and where to find the desired media content on the HTTP seeding server. Fake torrent files may convey to user device 12 that the underlying media content to which the torrent file describes is incomplete.

RAID box 30, mirrorbrain CDN 24 and/or other components of RAID CDN system 10 may be responsible for torrent file generation and distribution. RAID box 30 may generate fake torrent files either before or right after the media content has begun downloading but before all pieces of the requested media content have been fully downloaded. Mirrorbrain CDN 24 may generate a real torrent file once the media content has finished downloading. Track server 29 may keep track of which peer devices 44-46 accessed torrent files related to specific media content or subsets of the entirety of the media content. RAID CDN video server 18 may download the media content and distribute the media content to RAID box 30 and mirrorbrain CDN 24 to generate torrent files. Alternatively, fake torrent files may be generated by other components within RAID CDN system 10 or devices having functionality similar to RAID box 30. For example, fake torrent files may be generated by mirrorbrain CDN 24. Fake torrent files may also be updated by RAID box 30 and user browser 32 running RAIDCDN JavaScript. The fake torrent file updated by user browser 32 may be a copy of the fake torrent file initially generated by RAID box 30.

Data transfer to and from user browser 32 may be facilitated by MQTT 22 which may serve as a data or information hub from which information or messages sent to and from components within RAID CDN system 10 may be routed. For example, through MQTT 22, RAID box 30 may pass fake torrent files and mirrorbrain CDN 24 may pass real torrent files to user browser 32. User browser 32 may retrieve the torrent file from MQTT 22. MQTT may send an alert to user browser 32 every time a requested torrent file is posted to MQTT 22. After receiving the alert, user browser 32 may then retrieve the updated fake torrent file from MQTT 22. Alternatively, MQTT 22 may automatically pass user browser 32 the fake or real torrent file upon receiving the torrent file from RAID box 30 and mirrorbrain CDN 24. MQTT 22 may also temporarily store previously generated torrent files. RAIDCDN JavaScript may include logic to work with MQTT 22 to determine whether a torrent file has already been produced for a specific media content request.

Media content downloaded to RAID CDN video server 18 may be distributed to RAID box 30 and mirrorbrain CDN 24 for the generation of torrent files. The media content may also be distributed to RAID CDN 16 for storage of the media content. RAID CDN 16 may be one or more computing servers or computing devices having the functionality described herein. As RAID box receives additional media content from RAID CDN video server 18 or original CDN, RAID box 30 updates the fake torrent file. Fake torrent files may also be refreshed by user browser 32 running RAIDCDN JavaScript. RAIDCDN JavaScript may instruct RAID box 30 or user browser 32 to update or refresh the fake torrent file periodically at predetermined time periods. Alternatively, the fake torrent file may be refreshed after each segment of media content finishes downloading.

Fake torrent files may be particularly useful for streaming media content that has recently been recorded such as sporting events or news broadcasts. RAID CDN video server 18 and also in some cases user browser 32 may downloaded this media content from a traditional CDN or original content source such as Original CDN 20. After RAID CDN video server 18 has begun downloading the media content, this media content may be sent to RAID box 30 and a fake torrent file may be generated. This fake torrent file may be passed from RAID box 30 to MQTT 22 for distribution to user device 12 and other peer devices 44-46. User device 12 may retrieve the fake torrent file also download the media content from traditional CDNs or original content sources and periodically update the fake torrent file. In this way, user device 12 may seed the recently recorded broadcast. When all pieces of media content have been downloaded, mirrorbrain CDN 24 which will have received all the media content pieces from RAID CDN video server 18 may generate a real torrent file. Mirrorbrain CDN 24 may distribute the real torrent file to MQTT 22 which will replace or overwrite the fake torrent file. In this manner, user device 12 and peer devices 44-46 may access recently recorded media content almost immediately instead of having to wait until the complete media content file has been downloaded.

RAID CDN system 10 may be designed and configured to prioritize media content from peer devices. When RAID CDN system 10 receives a request for media content, it may first confirm that a torrent file has been generated before. If the torrent file has been generated before, user browser 32 may retrieve the torrent file and may then seek media content from peer devices 44-46. However, if a torrent file has not been previously generated and thus peer devices 44-46 do not have the media content requested, RAID CDN video server 18 and user browser 32 may download the requested media content from traditional CDNs or original content sources such as original CDN 20. For the case where the torrent file has been generated before, RAID CDN video server 18 and user browser 32 may be instructed to seek content from traditional CDNs or original CDN 20 only when it is determined that peer devices 44-46 lack the desired content or if it is determined that peer devices 44-46 having the desired media content are unreliable or do not have the necessary capacity for quality streaming. User browser 32 running RAIDCDN JavaScript may provide the user, through a graphic user interface (GUI) on user browser 32, the option to retrieve media content from CDNs only. As explained below, the embedded RAIDCDN JavaScript may keep track of or otherwise be responsible for determining which CDNs have the desired media content.

RAIDCDN JavaScript may include logic to determine the best and most cost efficient CDNs to download media content from. For example, RAIDCDN JavaScript may retrieve historical information regarding the cost, capacity, reliability and geographic information of each CDN. Alternatively, RAIDCDN JavaScript may arrange for RAID CDN video server 18 and/or user device 12 to sample the download quality of a CDN before selecting that CDN for downloading the media content. The best and most reliable CDNs to download the media content from may change throughout the download and as such RAIDCDN JavaScript may arrange for RAID CDN video server 18 and/or user device 12 to switch mid-download between different CDNs. Furthermore, RAIDCDN JavaScript may arrange for RAID CDN video server 18 and/or user device 12 to download the media content pieces occurring chronologically earlier from more expensive but more reliable CDNs and download the media content pieces occurring chronologically later from the cheaper but less reliable CDNs.

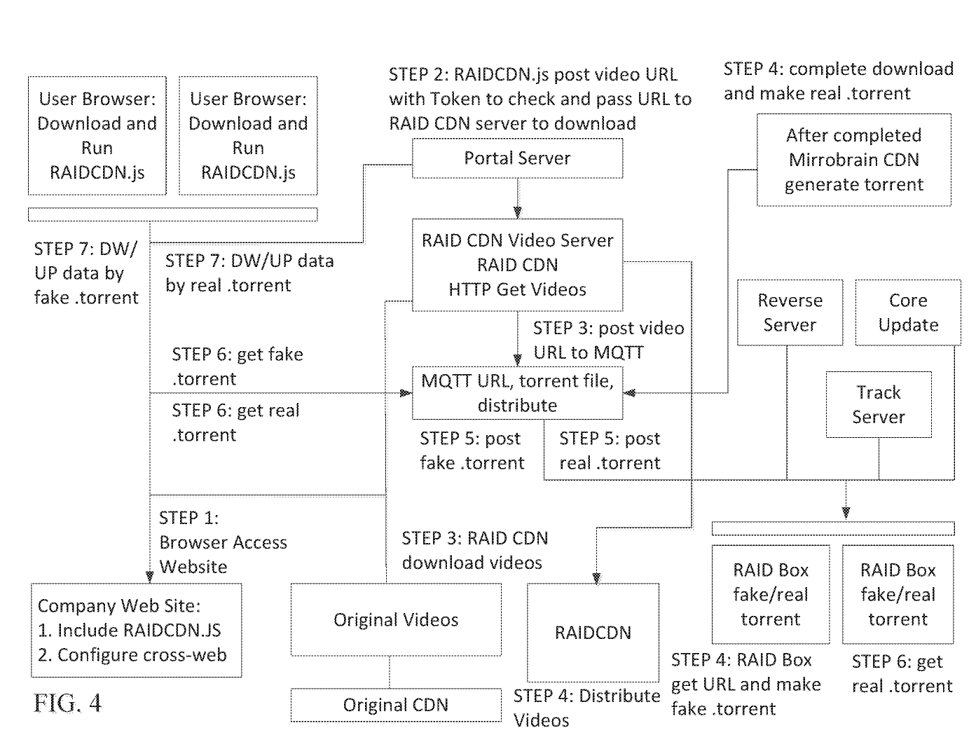

Referring now to FIG. 4, the general information data flow of RAID CDN system 10 is illustrated. As shown in FIG. 3, the method for streaming media content begins with STEP 1 wherein user browser 32 accesses company website 14 and downloads and runs the RAIDCDN JavaScript. Running RAIDCDN JavaScript, media content may be requested by user browser 32 from company website 14.

At STEP 2, after the media content is selected on company website 14, an access request for the URL corresponding to the designated media content may be redirected to portal server 26 along with a token to be validated by portal server 26. Once the token is validated, the URL is passed to RAID CDN video server 18. At STEP 3, RAID CDN video server 18 posts the URL to MQTT 22. If the request has been made before, then STEP 6 will be initiated to retrieve the torrent file from MQTT 22. Then at STEP 7 user browser 32 may download the media content from the content source or content sources as directed by the torrent file.

At STEP 4, in cases where the request is a new request, the media content is downloaded by RAID CDN video server 18 from an original or traditional CDNs and a fake torrent file is generated by RAID box 30 and is distributed and posted to MQTT 22 at STEP 5. As illustrated in FIG. 7, user browser 32 may also download media content from original or traditional CDNs. When the download of the new media content is complete, mirrorbrain CDN 24 generates a real torrent file corresponding to the complete media content file downloaded which is distributed and posted to MQTT 22, also at STEP 5. At STEP 6, user devices may retrieve the torrent files from MQTT 22. At STEP 7, user devices may download the media content from the content sources as directed by the torrent files.

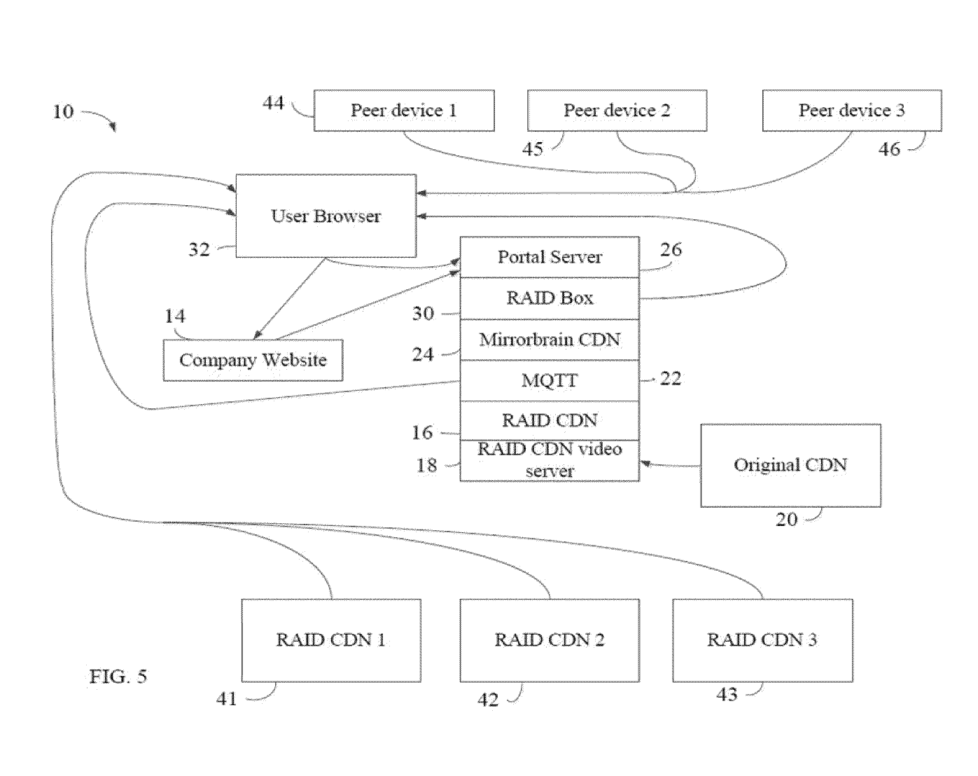

Referring now to FIG. 5, an exemplary RAID CDN system is shown having multiple RAID CDNs 41-43 and multiple peer devices 44-46. The flow of content and information within the exemplary RAID CDN system is illustrated. As is show in FIG. 5, media content may be available in RAID CDN system 10 from multiple RAID CDNs 41-43 as well as peer user devices 44-46 and even RAID box 30. As explained above, to improve the download time of media content, the media content may be divided into distinct pieces. The distinct pieces may then be downloaded from multiple RAID CDNs 41-43 and peer devices 44-46 that have the specific media content desired. The media content may also be downloaded from RAID box 30. By downloading the media content pieces at the same time, the time it takes to download the complete media file may be reduced. Additionally, the risk of delay caused by a single content source may also be reduced. Duplicate media content pieces may also be downloaded in parallel from different content sources to permit mid-download switching between the content sources. As shown in FIG. 5, user browser 32, running RAIDCDN JavaScript, may establish a direct connection with RAID CDNs 41-43, peer devices 44-46 and RAID box 30 over the Internet, using cellular technology or by making a one-to-one connection to download the media content.

The embedded RAIDCDN JavaScript may determine the best peers and RAID CDN servers to download the media content from. The best content sources may be defined by a number of factors including, for example, proximity to user browser 32, download/upload speed, capacity and reliability. To determine the best content sources to download from, embedded RAIDCDN JavaScript may analyze historical data regarding download speeds for each peer device 44-46 and RAID CDN server in possession of the media content desired. Peer devices 44-46 and RAID CDN servers may be required to maintain historical data about download and upload histories, connectivity information, and problems encountered during past uploads and downloads.

The embedded RAIDCDN JavaScript may also take into account cost. The cost of downloading media content from a RAID CDN can vary depending on the capacity of the RAID CDN as well as the geographic of location of the RAID CDN compared to user browser 32. Embedded RAIDCDN JavaScript may instruct RAID CDN user browser 32 to retrieve and download the desired media content pieces in the most cost efficient way possible while still maintaining quality. For example, embedded RAIDCDN JavaScript may arrange for the first pieces of the media content to be downloaded from the more expensive but more reliable RAID CDNs and for the pieces that are chronologically near the end of the media content file to be downloaded from the cheaper but slower RAID CDNs. Embedded RAIDCDN JavaScript may periodically recalculate which RAID CDNs and peer devices 44-46 are fastest and most reliable. If it is determined that a RAID CDN or peer device is no longer reliable or desirable, RAIDCDN JavaScript may arrange, mid-download, for the media content to be downloaded from a different RAID CDN or peer device.

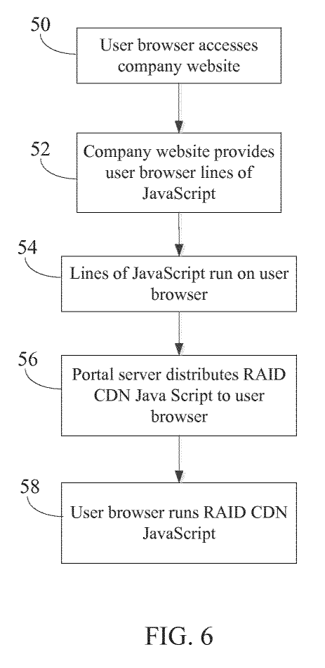

Referring now to FIG. 6, the process of accessing portal server 26 and other components of RAID CDN system 10 using user browser 32 is illustrated. This process may only be required the first time user browser 32 accesses company website 14. The process of accessing the portal server 26 begins at step 50 wherein user device 12 using user browser 32 accesses company website 14. Company website 14 is required to run RAIDCDN JavaScript and allow for cross-web to portal server 26. Company website 14 may require that user browser register and sign into company website 14. At step 52, company website 14 may provide user browser 32 a few lines of JavaScript after registration is complete. At step 54, user browser 32 will run the first few lines of JavaScript which will trigger portal server 26 to distribute RAIDCDN JavaScript to user browser 32. Once downloaded by user browser 32, at step 58 user browser 32 may run RAIDCDN JavaScript. RAIDCDN JavaScript running on user browser 32 will permit user browser 32 to send requests to portal server 26 and receive information such as torrent files from MQTT 22.

Referring now to FIG. 7, an exemplary embodiment of the RAID CDN architecture is illustrated wherein user browser 32 is making a new media content request. Once user browser 32 has registered with company website 14 and downloaded RAIDCDN JavaScript as shown in FIG. 6, at step 160, user browser 32 running RAIDCDN JavaScript, may select a media title such as a movie, television show or album name from company website 14. At step 162, once a specific title is selected, a URL related to that title along with a specific token identifying the company website client and other authenticating information are redirected to the portal server 26. At step 164, portal server 26 validates the token thereby validating the request. At step 166, portal server 26 may then pass the URL specific to the requested media content to RAID CDN video server 18. At step 168, RAID CDN video server 18 posts the URL to MQTT 22.

After the URL relating to the media content requested has been passed to MQTT 22, it must be determined whether the request has been made before and thus whether the requested URL has been downloaded before. As FIG. 7 illustrates the scenario where the request has not been made before, at step 170 RAIDCDN JavaScript will communicate with MQTT 22 to determine that this is a new media content request. At step 172, RAID CDN video server 18 will be instructed to begin downloading the media content from one or more traditional CDNs such as original CDN 20. RAID CDN video server 18 will pass the downloaded media content to RAID box 30 and mirrorbrain CDN 24 as each media content piece finishes downloading on RAID CDN video server and may also pass the media content to RAID CDN 16 to enable local downloads in the future. Once the RAID CDN video server has begun downloading the media content, at step 174 RAID box 30 will generate a fake torrent file and inform track server of media content pieces currently available. At this stage, there may be no media content currently available from RAID box 30. After generating the fake torrent file at step 174, at step 176 RAID box 30 will post the fake torrent file to MQTT 22.

Also after step 176, steps 202-214 and 180-198 may take place. At step 202, after RAID CDN video server 18 has begun downloading the media content from one or more traditional CDNs or Original CDN 20, it must be determined whether track server provides content sources for missing media content. Though RAID CDN video server 18 will distribute the downloaded media content to RAID box 30, RAID box 30 will seek to find the desired media content from other content sources in communication with track server 29 as well. RAIDCDN JavaScript may work with RAID box 30 and track server 29 to make this determination. RAIDCDN JavaScript must compare the media content RAID box 30 has already received from RAID CDN video server 18 to the media content available from the content sources identified by track server 29. If it is determined at step 202, that track server 29 does not provide content sources for media content that RAID box 30 does not already have, then at step 210 RAID CDN video server 18 will continue to download media content and continue to distribute the downloaded media content to RAID box 30, mirrorbrain CDN 24 and RAID CDN 16. As each new media content piece is distributed to RAID box 30, RAID box 30 updates the fake torrent file and informs track server 29 of the newly downloaded media content at step 212. If instead, at step 202 it is determined that track server 29 has information regarding media content that RAID box 30 doesn't already have, at step 204 RAID box 30 will retrieve information regarding the content sources having the desired content. The content sources may include other RAID boxes and peer devices. At step 206, RAID box 30 will download the missing media content according to the information received from track server 29. At step 208, RAID Box will update the fake torrent file with the newly downloaded media content and inform track server of the newly downloaded media content.

After step 208 and after step 212, a determination must be made of whether all media content pieces for the requested media content have been downloaded. RAIDCDN JavaScript may make this determination with RAID Box 30. If it is determined at step 214 that all media content pieces have finished downloading, at step 216, mirrorbrain CDN 24 will generate a real torrent file and post the real torrent file to MQTT 22. At this point the process is complete and a other user devices may receive the real torrent file from MQTT 22. However, if at step 214 it is determined that not all the media content pieces have finished downloading, steps 202 to 214 will be repeated until all of the media content pieces have finished downloading. Media content pieces may be downloaded in sequence or even out of sequence. For example, a RAID CDN system server may download media content pieces near the end of the media content file while user browser 32 simultaneously downloads media content pieces near the beginning of the media content file. This determination at step 214 may be made after each piece of media content is downloaded or after a predetermined number of media content pieces have been downloaded.

Also after step 176, at the same time as steps 202-214, user browser 32 may retrieve a copy of the fake torrent file from MQTT 22 at step 180. Upon retrieving a copy fake torrent file from MQTT 22, at step 182, user browser 32 will download the first media content piece or first few media content pieces from a traditional CDN such as original CDN 20. Upon downloading the first media content piece or first few media content pieces, at step 184 user browser 32 will update its copy of the fake torrent file to reflect the newly downloaded media content and will also inform track server 29 of the newly downloaded media content pieces. After downloading the first few pieces of media content and informing the track server of the newly downloaded media content, a determination must be made of whether track server 29 provides content sources for media content that user browser 32 doesn't have yet. RAIDCDN JavaScript must compare the media content user browser 32 already has received to the media content available from the content sources identified by track server 29.

If it is determined at step 186 that track server 29 does not provide content sources for media content that user browser does not yet have, then at step 194 user browser 32 downloads missing media content pieces from traditional CDNs such as original CDN 20. For example, user browser 32, may download the next piece of media content that user browser 32 does not have. At step 196, user browser 32 updates its copy of the fake torrent file to reflect the newly downloaded media content piece or pieces and informs track server of the newly downloaded media content.

If instead at step 186, track server 29 does provide content sources for media content that user browser does not yet have, user browser at step 188 will receive the information regarding the content source or content sources having the missing media content through track server 29. At step 190, user browser 32 may download the missing media content from the sources identified by track server 29. The content sources that may have the missing media content at step 190 include RAID boxes and peer devices. At step 192, user browser 32 updates its fake torrent file to account for the newly downloaded media content piece or pieces and informs track server of the newly downloaded media content.

After step 192 and after 196, at step 198 it must be determined whether all of the media content pieces have been downloaded by user browser 32. If it is determined at step 198 that all media content pieces have been downloaded by user browser 32, then the process is complete and user browser 32 may now seed the entire media content file. However, if at step 198 it is determined that not all the media content pieces have finished downloading, steps 186 to 198 will be repeated until all of the media content pieces have finished downloading. The RAID CDN system may be configured to periodically ask the question of whether track server 29 provides content sources for media content that user browser does not yet have. The determination at step 198 may be made after each piece of media content is downloaded or after a predetermined number of media content pieces have been downloaded. User browser 32 may download, simultaneously, the media content from traditional CDNs and the media content identified by track server 29.

Referring now to FIG. 8, an exemplary embodiment is illustrated wherein the user browser 32 is making a media content request that has already been made by another user device and wherein the user browser also updates the fake torrent file. Like in the architectures described above, once user browser 32 has registered with company website 14 and downloaded RAIDCDN JavaScript as shown in FIG. 6, at step 220, user browser 32 running RAIDCDN JavaScript, may select a media title such as a movie, television show or album name from company website 14. At step 222, once a specific title is selected, a URL related to that title along with a specific token identifying the company website client and other authenticating information are redirected to the portal server. At step 224, portal server 26 validates the token thereby validating the request. At step 226, portal server 26 may then pass the URL specific to the requested media content to RAID CDN video server 18. At step 228, RAID CDN video server 18 passes the URL to MQTT 22.

After the URL relating to the media content requested has been passed to MQTT 22, it must be determined whether the request has been made before and thus whether the requested URL has been downloaded before. As FIG. 8 illustrates the scenario where the request has been made by another user device before, at step 230 RAIDCDN JavaScript will communicate with MQTT 22 to determine that this media content request has previously been made by another user device. As this media content request has been made before, a real torrent file or at least a fake torrent file will have been previously generated and posted to MQTT 22. A fake torrent file may only be available if the request was recently made and the media content has not yet finished downloading. At step 232, a copy of the torrent file, real or fake, will be retrieved from MQTT 22 and downloaded by user browser 32.

At step 237 it must be determined whether the torrent file downloaded is a real torrent file or fake torrent file and thus whether the track server provides content sources for all content pieces. This determination may be made by RAIDCDN JavaScript and track server 29. If it is determined at step 237 that the torrent file was a real torrent file and thus provides media content sources for all of the media content pieces, then at step 234, user browser 32 downloads media content according to the torrent file. At step 236, user browser 32 informs track server 29 that user browser is now a seeder. User browser 32 may then seed the entire media content file.

If it is determined at step 237 that the torrent file was a fake torrent file and thus does not provide content sources for all media content pieces requested, then a determination of whether track server 29 provides content sources for media content that user browser 32 does not yet have must be made at step 242. This determination may be made by RAIDCDN JavaScript by comparing the media content pieces unavailable from the torrent file to the media content for which track server 29 provides content sources for. If at step 242, it is determined that track server does not provide content sources for media content that user browser 32 does not yet have, then at step 244 user browser 32 may download missing media content pieces from traditional CDNs such as original CDN 20. For example, user browser 32, may download the next piece of media content that user browser 32 does not have. The number of media content pieces downloaded from traditional CDNs such as original CDN 20 may be predetermined. At step 246, user browser 32 may update its copy of the fake torrent file to account for the newly downloaded media content piece or pieces and inform track server of the newly downloaded media content.

If instead at step 242, track server 29 does provide content sources for one or more pieces of media content that user browser doesn't have, user browser 32 at step 248 will receive the information regarding the content source for the missing media content through track server 29. At step 250, user browser 32 may download one or more missing media content from the sources identified by track server 29. The content sources at step 250 may include peer devices and RAID boxes. At step 252, user browser 32 may update the fake torrent file to account for the newly downloaded media content piece or pieces and inform track server of the newly downloaded media content. After 252 and 246, at step 254 it must be determined whether all of the media content pieces have been downloaded by user browser 32. This determination may be made after each piece of media content is downloaded or after a predetermined number of media content pieces have been downloaded. If it is determined at step 254 that all media content pieces have been downloaded by user browser 32, then the process is complete and user browser 32 may now seed the entire media content file. However, if at step 254 it is determined that not all the media content pieces have finished downloading, steps 242 to 254 will be repeated until all of the media content pieces have finished downloading. The RAID CDN system may be configured to periodically ask whether track server 29 provides content sources for the media content that user browser does not have. The answer to this question may change over time as other content sources may have downloaded the desired media content since inquiry. This determination may be made while media content is currently being downloaded by user browser 32.

A user device that has begun downloading the fake torrent file may be permitted to download the complete media content file using the fake torrent file only as the fake torrent file will continuously be refreshed until all of the media content has been downloaded. In this manner, a user device that has downloaded a fake torrent file will have no need for a real torrent file. However, the real torrent file may still be generated and stored in MQTT 22 or RAID box for future requests from other peer devices 44-46.

In some cases it may be possible for a user that is not a registered user of company website 14, or not otherwise authorized to access company website 14, to access RAID CDN system 10. A non-member may be permitted access to the media content stored on peer devices 44-46 or RAID CDN system servers by paying a one-time user fee. In this scenario, the non-member user may access a non-member website that is configured for the pay-per-use model. The website available to non-member users may provide media titles that are available for a one-time use fee. After paying a fee, the non-member user may select a single media title from the website and proceed to download a fake or real torrent file and subsequently download the desired media content in a manner similar to that shown in FIGS. 7-8. The non-member website may be the same as company website 14 or may be affiliated or otherwise related to company website 14. The non-member user may still be considered a peer device from which user device 12 may download media content from.

In an alternative architecture, media content that has not previously been requested may also or alternatively be retrieved using a traditional torrent infrastructure. Media content may be sought from content sources outside of RAID CDN system 10 where RAID CDN system 10 does not have the desired media content or where an insufficient number of peer devices 44-46 having the requested media content are available to support reliable media content streaming. In this manner, the traditional torrent infrastructure will be an alternative to seeking media content from traditional or original CDNs. For example, in the architectures in FIGS. 7 and 8, as an alternate to seeking media content from traditional or original CDNs, embedded RAIDCDN JavaScript may connect with a traditional torrent network outside of RAID CDN system 10. Specifically, embedded RAIDCDN JavaScript may contact a track server of a traditional torrent network and inquire whether the media content requested is available in the traditional torrent network. If it is determined that a traditional torrent network does have the requested media content, the torrent file for the requested media content may be downloaded. Where the torrent file is downloaded to RAID CDN video server 18 or RAID box 30, the torrent file may be posted to MQTT 22 and made available to user devices. By downloading the torrent file, user devices in the RAID CDN system 10 may access media content from devices in the traditional torrent network.

In an alternative embodiment, embedded RAIDCDN JavaScript run on user browser 32, may also include functionality similar to that of track server 29. In this embodiment, the embedded RAIDCDN JavaScript may determine which peer devices 44-46 to download the media content pieces from and inform components of RAID CDN system 10 which pieces of media content are currently available from which peer devices. To keep track of media content, a distributed hash table may be used by the network of user devices in RAID CDN system 10 running RAIDCDN JavaScript. A distributed hash table is used for tracking the specific content that each user device has. A distributed hash table uses a distributed key value lookup wherein the storage of the values is distributed across the peer user devices. In this system, each user device is responsible for tracking the media content of a certain number of other user devices. The devices that each user device is responsible for tracking may continuously change according to which devices are online and the proximity of peer devices 44-46 that the user device comes in contact with. The peer user devices for which each user device is responsible for tracking is designed to be close in proximity to that user device. Accordingly, user device 12 ends up knowing the most about the content of the peers closest in proximity to user device 12. When user device 12 is seeking specific pieces of media content, the user device will first ask the peer devices for which it is responsible for tracking whether they have the pieces of media content. If the peer devices do not have the media content requested, they will provide the requesting user device with contact information for peer devices 44-46 that may be responsible for tracking the content user device 12 is seeking. In this manner the user devices are akin to small track servers.

In all of the architectures discussed above, after user browser 32 has downloaded media content from various content sources, user browser 32 may then serve as a content source itself. In this way, user browser 32 may offer peer user devices one or more segments of the media content downloaded by user device 12 by permitting the peer user browsers access the media content.

While various illustrative embodiments of the invention are described above, it will be apparent to one skilled in the art that various changes and modifications may be made therein without departing from the invention. For example, RAID CDN system 10 may include additional components of various types and functionality or even fewer components. Also, while the present invention has been described in terms of using JavaScript, one of skill in the art would recognize that any scripting language may be used, or the intended operation can be imbedded in an application instead of a scripting language. Furthermore, the implementation of the fake torrent file described herein is only an example. It is understood that, as long as the fake torrent file is different than the real torrent file, there may be many ways to implement the fake torrent file, including but not limited to how the fake torrent file is created, when the fake torrent file is created, where the fake torrent file is created, and under what format the fake torrent file is created. The appended claims are intended to cover all such changes and modifications that fall within the true spirit and scope of the invention.

What is claimed is:

1. A method for facilitating data transfer between a user browser and content sources, the method comprising:
receiving a request for media content from the user browser;
inquiring whether the requested media content has been previously requested;
if the media content has not previously been requested, downloading at a video server at least one file of multiple files comprising the media content from at least one original content source and informing a track server upon downloading the at least one file of multiple files comprising the media content;
passing at least one file of multiple files comprising the media content to a RAID box upon the at least one file of multiple files comprising the media content being downloaded to the video server; and
generating a fake torrent file at the RAID box.

2. The method of claim 1, further comprising providing a copy of the fake torrent file to the user browser.

3. The method of claim 2, further comprising:
determining that the track server provides content sources for the at least one file of the of multiple files comprising the media content that user browser has not downloaded yet;
instructing the user browser to receive information through the track server regarding content sources having the at least one file of the multiple files comprising the media content that the user browser has not downloaded yet;
instructing the user browser to, upon downloading the at least one file of the multiple files comprising the media content that user browser has not downloaded yet, update the fake torrent file with information regarding the at least one file of the multiple files comprising the media content downloaded by user browser; and
instructing the user browser to inform the track server that the user browser has downloaded the at least one file of the multiple files comprising the media content.

4. The method according to claim 3, further comprising:
inquiring whether all files of the multiple files comprising the media content have been downloaded to the user browser; and
if all files of the multiple files comprising the media content have not been downloaded to the user browser, inquiring again whether the track server provides content sources for files of the multiple files comprising the media content that user browser has not downloaded yet.

5. The method of claim 4, further comprising:
determining that the track server does provide content sources for at least one file of the multiple files comprising the media content that user browser has not downloaded yet;
instructing user browser to receive information through the track server regarding content sources having at least one file of the multiple files comprising the media content that user browser has not downloaded yet;
instructing the user browser to, upon downloading the at least one file of the multiple files comprising the media content that user browser has not downloaded yet, update the fake torrent file to indicate the user browser has downloaded the at least one file of the multiple files comprising the media content; and
instructing the user browser to inform the track server that the user browser has downloaded the at least one file of the multiple files comprising the media content.

6. The method of claim 4, further comprising,
determining that the track server does not provide content sources for at least one file of the multiple files comprising the media content that the user browser has not downloaded yet;
instructing the user browser to download at least one file of the multiple files comprising the media content from the at least one original content source;
instructing the user browser to, upon downloading at least one file of the multiple files comprising the media content from the at least one original content source, update the fake torrent file with information regarding the at least one file of the multiple files comprising the media content that has been downloaded by the user browser; and
informing the track server that the user browser has downloaded the at least one file of the multiple files comprising the media content.

7. The method of claim 2, further comprising:
determining that the track server does not provide content sources for files of the multiple files comprising the media content that the user browser has not downloaded yet;
instructing the user browser to download at least one file of the multiple files comprising the media content from the at least one original content source;
instructing the user browser to, upon downloading at least one file of the multiple files comprising the media content from the at least one original content source, update the fake torrent file with information regarding the at least one file of the multiple files comprising the media content that has been downloaded by the user browser; and
informing the track server that the user browser has downloaded the at least one file of the multiple files comprising the media content.

8. The method according to claim 2, further comprising:
determining that the track server does provide content sources for at least one file of the multiple files comprising the media content that RAID box has not downloaded yet;
receiving from the track server information regarding content sources having at least one file of the multiple files comprising the media content that RAID box has not downloaded yet;
downloading at the RAID box at least one file of the multiple files comprising the media content that RAID box has not downloaded yet;
updating the fake torrent file after the RAID box has downloaded the at least one file of the multiple files comprising the media content with information regarding the at least one file of the multiple files comprising the media content that RAID box has not downloaded yet; and
informing the track server that the RAID box has downloaded the at least one file of the multiple files comprising the media content.

9. The method according to claim 8, further comprising:
inquiring whether all files of the multiple files comprising the media content have been downloaded to the RAID box; and
if all files of the multiple files comprising the media content have not been downloaded to the RAID box, inquiring again whether the track server provides content sources for at least one file of the multiple files comprising the media content that RAID box has not downloaded yet.

10. The method according to claim 9 further comprising:
determining that all files comprising the media content have been downloaded to the RAID box; and
generating a real torrent file at a mirrorbrain CDN.

11. The method according to claim 9, further comprising:
determining that the track server does provide content sources for at least one file of the multiple files comprising the media content that RAID box has not downloaded yet;
receiving from the track server information regarding content sources having the at least one file of the multiple files comprising the media content that RAID box has not downloaded yet;
downloading at the RAID box at least one file of the multiple files comprising the media content that RAID box has not downloaded yet;
updating the fake torrent file after the RAID box has downloaded at least one file of the multiple files comprising the media content with information regarding the at least one file of the multiple files comprising the media content; and
informing the track server that the RAID box has downloaded the at least one file of the multiple files comprising the media content.

12. The method according to claim 9, further comprising:
determining that the track server does not provide content sources for at least one file of the multiple files comprising the media content that RAID box has not downloaded yet;
continuing to download at the video server files of the multiple files comprising the media content from the at least one original content source;
continuing to distribute to RAID box files of the multiple files comprising the media content downloaded at the video server;
updating the fake torrent file after the RAID box has received the files of the multiple files comprising the media content with information regarding the files of the multiple files comprising the media content recently downloaded by RAID box; and
informing the track server that the RAID box received the files of the multiple files comprising the media content.

13. The method according to claim 2, further comprising:
determining that the track server does not provide content sources for files of the multiple files comprising the media content that RAID box has not downloaded yet;
continuing to download at the video server files of the multiple files comprising the media content from the at least one original content source;
continuing to distribute to RAID box files of the multiple files comprising the media content downloaded at the video server;
updating the fake torrent file after the RAID box has received the files of the multiple files comprising the media content with information regarding the files of the multiple files comprising the media content; and
informing the track server that the RAID box has downloaded the files of the multiple files comprising the media content.

14. A method for facilitating data transfer between a user browser and content sources, the method comprising:
receiving a request for media content from the user browser;
determining that the requested media content has been previously requested;
instructing the user browser to download a torrent file which may be a fake torrent file or a real torrent file; and
determining that the torrent file downloaded by user browser is not a real torrent file but is instead a fake torrent file.

15. The method according to claim 14, further comprising:
determining that the track server does provide information regarding content sources having at least one file of the multiple files comprising the media content that the user browser does not have yet;
instructing the user browser to download at least one file of the multiple files comprising the media content according to the fake torrent file; and
instructing user browser to update the track server upon downloading at least one file of the multiple files comprising the media content that user browser has downloaded the at least one file.

16. The method according to claim 15, further comprising:
upon downloading at least one file of the multiple files comprising the media content according to the fake torrent file, inquiring whether the track server provides information regarding content sources having at least one file of the multiple files comprising the media content that the user browser does not have yet;
determining that the track server does provide information regarding content sources having at least one file of the multiple files comprising the media content that the user browser does not have yet;
instructing the user browser to receive information from track server regarding the content sources having the at least one file of the multiple files comprising the media content that the user browser does not have yet; and
instructing the user browser to, upon downloading the at least one file of the multiple files comprising the media content from the content sources, update the fake torrent file with information regarding the at least one file of the multiple files comprising the media content that has been downloaded by the user browser; and
informing the track server that the user browser has downloaded the at least one file of the multiple files comprising the media content.

17. The method according to claim 15, further comprising:
upon downloading the at least one file of the multiple files comprising the media content according to the fake torrent file, determining that the track server does not provide information regarding content sources having at least one file of the multiple files comprising the media content that the user browser does not have yet;
instructing the user browser to download at least one file of the multiple files comprising the media content that the user browser does not have yet from the at least one original content source;
instructing the user browser to, upon downloading the at least one file of the multiple files comprising the media content from the at least one original content source, update the fake torrent file with information regarding the at least one file of the multiple files comprising the media content that has been downloaded by the user browser; and
informing the track server that the user browser has downloaded the at least one file of the multiple files comprising the media content.

18. A media distribution system permitting data transfer, the system comprising:
a RAID CDN system comprising at least a video server and a RAID box; and
a user device configured to run a user browser and execute non-transitory computer readable medium facilitating communication between the user browser and the RAID CDN system,
wherein the video server is configured to download multiple files comprising the media content and distribute the multiple files comprising the media content to other components of the RAID CDN system, and
wherein the RAID box is configured to receive the multiple files comprising the media content from the video server, store the multiple files comprising the media content and generate a fake torrent file.

19. The system according to claim 18, further comprising a messaging distribution server configured to facilitate communication and data transfer between the user device and components of the RAID CDN system.

20. The system according to claim 19, wherein the RAID CDN system further comprises a mirrorbrain server configured to generate a real torrent file after all files of the multiple files comprising the media content have been downloaded to mirrorbrain server, wherein the real torrent file provides information regarding the multiple files comprising the media content file.
